(19) United States
(12) Patent Application Publication
(10) Pub. No.: US 2026/0139128 A1
(43) Pub. Date: May 21, 2026

(54) MODIFIER FOR POLYAMIDE RESINS AND POLYAMIDE RESIN COMPOSITION

(71) Applicant: KANEKA CORPORATION, Osaka (JP)

(72) Inventor: Yu Suganomata, Takasago-shi (JP)

(73) Assignee: KANEKA CORPORATION, Osaka (JP)

(21) Appl. No.: 19/390,996

(22) Filed: Nov. 17, 2025

(30) Foreign Application Priority Data
Nov. 18, 2024 (JP) 2024-200913

(51) Int. Cl. C08L 9/00; C08L 33/08; C08L 77/02; C08L 77/06

(52) U.S. Cl. CPC C08L 9/00; C08L 33/08; C08L 77/02; C08L 77/06; C08L 2207/53; C08L 2310/00

(57) ABSTRACT

A modifier for polyamide resins that can improve the impact strength and fluidity of a polyamide resin composition while keeping its high visual quality intact is provided. The modifier for polyamide resins contains polymer particles and an acid. Each of the polymer particles has a core-shell structure composed of a shell layer and one or more core layers. At least one of the core layers is formed of polybutadiene, poly(butadiene-styrene), or acrylic rubber. The shell layer is formed of a polymer comprising structural units derived from monomer components containing 50 wt % or more of a methacrylic ester monomer and 0 to 50 wt % of another monomer copolymerizable with the methacrylic ester monomer.

### TECHNICAL FIELD

One or more embodiments of the present invention relate to a modifier for polyamide resins and a polyamide resin composition containing the modifier.

### BACKGROUND

A conventionally known technique for improving the impact resistance of a thermoplastic resin is to incorporate a graft copolymer containing a rubber component into the thermoplastic resin.

However, when the thermoplastic resin is a polyamide resin, the rubber-containing graft copolymer is not sufficiently dispersed in the polyamide resin because, in general, polyamide resins and rubber-containing graft copolymers are poorly compatible. Thus, incorporating a rubber-containing graft copolymer into a polyamide resin does not necessarily provide a satisfactory enhancing effect on the impact strength of the polyamide resin. In addition, when the impact strength of a polyamide resin is enhanced by incorporation of a rubber-containing graft copolymer, the resulting composition has low melt fluidity and therefore exhibits poor moldability.

Patent Literature 1 describes a modifier for polyamide resins that can enhance the impact strength of a polyamide resin. The modifier is composed of polymer particles having a core-shell structure and having a specific volume mean diameter. The core layer is formed of polybutadiene or poly(butadiene-styrene), and the shell layer is formed of a polymer containing a specific amount of methacrylic ester monomer. The polymer of the shell layer contains a hydroxy group-containing vinyl monomer as a constituent monomer.

### PATENT LITERATURE

PTL 1: Japanese Laid-Open Patent Application Publication No. 2022-138238

### SUMMARY

An investigation by the present inventor has revealed that incorporation of the modifier of Patent Literature 1 into a polyamide resin composition deteriorates the visual quality of the polyamide resin composition. A modifier for polyamide resins that can improve the impact strength and fluidity of a polyamide resin composition while keeping its high visual quality intact is provided.

One or more embodiments of the present invention relate to a modifier for polyamide resins, the modifier containing polymer particles and an acid, wherein each of the polymer particles has a core-shell structure composed of a shell layer and one or more core layers, at least one of the core layers is formed of polybutadiene, poly(butadiene-styrene), or acrylic rubber, and the shell layer is formed of a polymer comprising structural units derived from monomer components containing 50 wt % or more of a methacrylic ester monomer and 0 to 50 wt % of another monomer copolymerizable with the methacrylic ester monomer.

One or more embodiments of the present invention can provide a modifier for polyamide resins that can improve the impact strength and fluidity of a polyamide resin composition while keeping its high visual quality intact.

### DETAILED DESCRIPTION

Hereinafter, one or more embodiments of the present invention will be described in detail.

### [Modifier for Polyamide Resins]

A modifier for polyamide resins according to the present embodiment contains: polymer particles that are particles of a graft copolymer; and an acid.

### (Polymer Particles)

Each of the polymer particles contained in the modifier for polyamide resins according to the present embodiment has a core-shell structure composed of a shell layer and one or more core layers. The shell layer refers to a polymer layer forming the outer surface of the polymer particle, and is also referred to as a graft layer. The core layer refers to a polymer layer located inside the shell layer in the polymer particle, and is formed of a rubbery polymer. The particle may include only one core layer or may include two or more core layers differing in the compositions of monomers. The shell layer covers the surface of the core layer, but is not limited to covering the entire surface of the core layer and may cover at least a part of the surface of the core layer.

### (Core Layer)

The core layers of the polymer particles are formed of a rubbery polymer. At least one of the core layers may be formed of polybutadiene, poly(butadiene-styrene), or acrylic rubber. All of the core layers may be formed of polybutadiene, poly(butadiene-styrene), or acrylic rubber. In terms of thermal stability, acrylic rubber is preferred.

The polybutadiene or poly(butadiene-styrene) may not contain a vinyl monomer other than butadiene and styrene, or may contain such a vinyl monomer. Examples of such a vinyl monomer include: aromatic vinyl monomers such as α-methylstyrene (excluding styrene); (meth)acrylic acids and (meth)acrylic alkyl esters such as acrylic acid, methacrylic acid, ethyl acrylate, butyl acrylate, 2-ethylhexyl acrylate, methyl methacrylate, ethyl methacrylate, butyl methacrylate, 2-hydroxyethyl methacrylate, and glycidyl methacrylate; and unsaturated nitrile monomers such as acrylonitrile and methacrylonitrile.

The polybutadiene or poly(butadiene-styrene) may be produced by polymerization using a polyfunctional monomer such as divinylbenzene, allyl methacrylate, ethylene glycol dimethacrylate, or 1,3-butylene dimethacrylate.

The polybutadiene or poly(butadiene-styrene) may be produced by polymerization without the use of any chain transfer agent, but may be obtained by polymerization in the presence of a chain transfer agent. The use of a chain transfer agent enhances the impact strength of the polyamide resin composition according to the present embodiment at ambient and low temperatures, making it likely that, in impact testing of the composition at ambient and low temperatures, the occurrence of brittle fracture decreases while the occurrence of ductile fracture increases. Examples of chain transfer agents that can be used include, but are not limited to: alkyl mercaptans such as n-dodecyl mercaptan, t-dodecyl mercaptan, t-decyl mercaptan, n-decyl mercaptan, and n-octyl mercaptan; and alkyl ester mercaptans such as 2-ethylhexyl thioglycolate.

When a chain transfer agent is used, the amount of the chain transfer agent is not limited to a particular range, but may be from 0.01 to 3 wt % based on the total weight of the polybutadiene or poly(butadiene-styrene). When the amount of the chain transfer agent used is within this range, incorporation of the polymer particles into a polyamide resin can provide a stronger enhancing effect on the impact strength of the polyamide resin at ambient and low temperatures. The amount of the chain transfer agent used may be from 0.05 to 2 wt % or from 0.1 to 1 wt %.

Examples of the acrylic monomer of the acrylic rubber include, but are not limited to, acrylic alkyl esters such as methyl acrylate, ethyl acrylate, butyl acrylate, 2-ethylhexyl acrylate, octyl acrylate, dodecyl acrylate, stearyl acrylate, and behenyl acrylate; aromatic ring-containing acrylates such as phenoxyethyl acrylate and benzyl acrylate; hydroxyalkyl acrylates such as 2-hydroxyethyl acrylate and 4-hydroxybutyl acrylate; glycidyl acrylates such as glycidyl acrylate and glycidyl alkyl acrylates; and alkoxyalkyl acrylates. Among these, acrylic alkyl esters are preferred, and butyl acrylate is particularly preferred.

Another monomer may be used in combination with the acrylic monomer, or may not be used in combination with the acrylic monomer. Examples of the other monomer include: methacrylic monomers; aromatic vinyl compounds such as styrene; vinyl cyanide compounds such as acrylonitrile; vinyl halides such as vinyl chloride; vinyl acetate; and alkenes such as ethylene and propylene. The proportion of the acrylic monomer in the total weight of the acrylic rubber may be 50 wt % or more, 70 wt % or more, 80 wt % or more, or 90 wt % or more.

The acrylic rubber has a crosslinked structure. To introduce the crosslinked structure, for example, a polyfunctional monomer or a crosslinkable monomer such as a mercapto group-containing compound may be used when the polymer of the core layers is synthesized by polymerizing monomer components.

Examples of the polyfunctional monomer include: allyl (meth)acrylate; allylalkyl (meth)acrylates; allyloxyalkyl (meth)acrylates; polyfunctional (meth)acrylates having two or more (meth)acrylic groups such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; diallyl phthalate; triallyl cyanurate; triallyl isocyanurate; and divinylbenzene. Allyl (meth)acrylate, triallyl isocyanurate, butanediol di(meth)acrylate, and divinylbenzene are preferred. Particularly preferred is allyl methacrylate.

The total amount of polyfunctional monomers used in the acrylic rubber may be from 0.01 to 10 parts by weight, from 0.05 to 5 parts by weight, or from 0.1 to 3 parts by weight per 100 parts by weight of the total weight of acrylic rubber-forming monomer components (monomers other than the polyfunctional monomers).

The refractive index of the core layers is not limited to a particular range, but may be 1.43 or more. The use of the core layers with such a refractive index can improve the visual quality of the polyamide resin composition and minimize the deterioration of the visual quality of the polyamide resin due to incorporation of the polymer particles. The refractive index of the core layers may be at least 1.45, at least 1.48, at least 1.50, at least 1.51, or at least 1.52. The refractive index may be up to 1.58 or up to 1.57.

### (Shell Layer)

The shell layer is formed of a polymer comprising structural units derived from monomer components containing 50 wt % or more of a methacrylic ester monomer and 0 to 50 wt % of another monomer copolymerizable with the methacrylic ester monomer. Being formed of a polymer 50 wt % or more of which is constituted by structural units derived from a methacrylic ester monomer, the shell layer has a high glass transition temperature. Thus, the polymer particles are less likely to become coarse, and a latex of the polymer particles has good mechanical stability. This latex is suitable for industrial production.

Examples of the methacrylic ester monomer used to form the shell layer include, but are not limited to, methacrylic alkyl esters such as methyl methacrylate, ethyl methacrylate, n-butyl methacrylate, i-butyl methacrylate, t-butyl methacrylate, 2-ethylhexyl methacrylate, octyl methacrylate, dodecyl methacrylate, stearyl methacrylate, and behenyl methacrylate. Among these, methyl methacrylate is preferred. In order to avoid generation of isobutylene gas, which is flammable, during melt processing of the polyamide resin composition, it is preferable not to use t-butyl methacrylate.

The proportion of the methacrylic ester monomer in the total monomer components used to form the polymer of the shell layer is from 50 to 100 wt %. Since the methacrylic ester monomer accounts for half or more of the shell layer of each polymer particle, the polymer particles are less likely to become coarse in a powder preparation process in which a powder of the polymer particles is obtained from a latex, and thus the resulting polymer particles are uniformly dispersible in the polyamide resin. A further advantage is that a latex of the polymer particles has good mechanical stability. The proportion may be from 60 to 99 wt %, from 70 to 97 wt %, or from 75 to 95 wt %.

The monomer components of the polymer of the shell layer of each polymer particle may include, in addition to the methacrylic ester monomer, another monomer copolymerizable with the methacrylic ester monomer. Such a monomer is not limited to a particular compound, but may be an acrylic alkyl ester. Examples of the acrylic alkyl ester include methyl acrylate, ethyl acrylate, n-butyl acrylate, i-butyl acrylate, t-butyl acrylate, 2-ethylhexyl acrylate, octyl acrylate, dodecyl acrylate, stearyl acrylate, and behenyl acrylate. Among these, butyl acrylate is preferred.

The proportion of the other copolymerizable monomer in the total monomer components of the polymer of the shell layer is from 0 to 50 wt %. The proportion may be from 1 to 40 wt %, from 3 to 30 wt %, or from 5 to 25 wt %.

In terms of the compatibility between the polymer particles and the polyamide resin and the enhancing effect on impact strength at ambient and low temperatures, the proportion of the shell layers in the total weight of the polymer particles may be from 1 to 50 wt %, from 5 to 40 wt %, or from 10 to 30 wt %.

### (Reactive Functional Group)

The polymer particles may contain a constituent monomer unit having a reactive functional group, or may not contain such a constituent monomer unit. The term “reactive functional group” refers to a functional group capable of reacting with terminal amino and carboxy groups of a polyamide resin and with an amide group in the main chain of the polyamide resin to form hydrogen bonds. It should be noted that the term “reactive functional group” refers to such a functional group present in the polymer particles after polymer formation, and is not intended to include any reactive functional group that is present in monomer components before polymer formation and that is involved in polymer formation.

Examples of the reactive functional group include carboxy, acid anhydride, hydroxy, and amide groups. An acid anhydride group is a group represented by —CO—O—CO— which is formed through condensation between carboxy groups.

The proportion of a monomer unit having a reactive functional group in the constituent monomer units of the polymers of the polymer particles may be 5 wt % or less and may be 3 wt % or less. In this case, the fluidity of the polyamide resin composition can be further improved.

The proportion of a monomer unit having a reactive functional group in the constituent monomer units of the polymer of the shell layer may be 20 wt % or less and may be 10 wt % or less. In this case, the fluidity of the polyamide resin composition can be further improved.

### (Volume Mean Diameter of Polymer Particles)

In order to achieve stronger impact strength, the volume mean diameter of the polymer particles may be 100 nm or more, 120 nm or more, 140 nm or more, 150 nm or more, 160 nm or more, or 170 nm or more. However, the greater the diameter of the polymer particles, the longer the time required for the polymerization reaction and the lower the productivity. Thus, the volume mean diameter may be 400 nm or less, 350 nm or less, 300 nm or less, 250 nm or less, or 200 nm or less. As described in Examples, the volume mean diameter of the polymer particles is measured for a latex of the polymer particles using a particle size analyzer. Alternatively, the volume mean diameter of the polymer particles can be calculated using a transmission electron microscope (TEM) image of the polyamide resin composition. The diameter of the polymer particles can be controlled by factors such as the type or amount of a polymerization initiator, chain transfer agent, redox agent, or emulsifier, the polymerization temperature, and the polymerization time.

### (Method for Producing Polymer Particles)

The method for producing the polymer particles may be a common method, and is not limited to a particular technique. For example, bulk polymerization, solution polymerization, suspension polymerization, or emulsion polymerization can be used. Emulsion polymerization, in particular emulsion graft polymerization, is preferred. Specifically, in the case of emulsion graft polymerization, a latex of polymer particles corresponding to the core layers is first produced by emulsion polymerization, and then monomer components for forming the shell layers and a polymerization initiator are added to the latex, in which the monomer components are polymerized.

The emulsifier (dispersant) used in emulsion polymerization is not limited to a particular type. For example, an anionic surfactant, a non-ionic surfactant, a cationic surfactant, or an amphoteric surfactant can be used. A dispersant such as polyvinyl alcohol, alkyl-substituted cellulose, polyvinylpyrrolidone, or a polyacrylic acid derivative may be used. Examples of the anionic surfactant used as the emulsifier include, but are not limited to, the following compounds: fatty acid soaps such as potassium laurate, potassium cocoate, potassium myristate, potassium oleate, potassium oleate diethanolamine salt, sodium oleate, potassium palmitate, potassium stearate, sodium stearate, mixed fatty acid sodium soap, partially-hydrogenated tallow fatty acid sodium soap, and castor oil potassium soap; alkyl sulfate salts such as sodium dodecyl sulfate, sodium higher alcohol sulfate, triethanolamine dodecyl sulfate, ammonium dodecyl sulfate, sodium polyoxyethylene alkyl ether sulfate, triethanolamine polyoxyethylene alkyl ether sulfate, sodium polyoxyethylene alkyl phenyl ether sulfate, and sodium 2-ethylhexyl sulfate; sodium alkylbenzenesulfonates such as sodium dodecylbenzenesulfonate; sodium dialkyl sulfosuccinates such as sodium di-2-ethylhexyl sulfosuccinate; sodium alkylnaphthalenesulfonates; sodium alkyl diphenyl ether disulfonates; potassium alkyl phosphates; phosphate salts such as sodium polyoxyethylene lauryl ether phosphate; naphthalenesulfonic acid-formalin condensate sodium salt; polycarboxylic acid-type polymeric anions; sodium acyl (tallow) methyl taurate; sodium acyl (coco) methyl taurate; sodium cocoyl isethionate; α-sulfo fatty acid ester sodium salt; sodium amide ether sulfonate; oleyl sarcosine; sodium lauroyl sarcosinate; and rosin acid soap.

Examples of the non-ionic surfactant used as the emulsifier include, but are not limited to, the following compounds: polyoxyethylene alkyl allyl ethers or polyoxyethylene alkyl ethers such as polyoxyethylene nonyl phenyl ether, polyoxyethylene oleyl ether, and polyoxyethylene lauryl ether; polyoxyethylene sorbitan esters such as polyoxyethylene sorbitan monolaurate and polyoxyethylene sorbitan monostearate; polyoxyethylene fatty acid esters such as polyethylene glycol monolaurate, polyethylene glycol monostearate, and polyethylene glycol monooleate; and oxyethylene/oxypropylene block copolymer.

Examples of the cationic surfactant used as the emulsifier include, but are not limited to, the following compounds: alkylamine salts such as coconut amine acetate, stearylamine acetate, octadecylamine acetate, and tetradecylamine acetate; and quaternary ammonium salts such as lauryl trimethyl ammonium chloride, stearyl trimethyl ammonium chloride, cetyl trimethyl ammonium chloride, distearyl dimethyl ammonium chloride, alkylbenzyl dimethyl ammonium chloride, hexadecyl trimethyl ammonium chloride, and behenyl trimethyl ammonium chloride.

Examples of the amphoteric surfactant used as the emulsifier include, but are not limited to, the following compounds: alkyl betaines such as lauryl betaine, stearyl betaine, and dimethyl lauryl betaine; sodium lauryl diaminoethyl glycine; amide betaine; imidazoline; and lauryl carboxymethyl hydroxyethyl imidazolinium betaine.

One of the emulsifiers (dispersants) mentioned above may be used alone, or two or more thereof may be used in combination. The mean diameter of the polymer particles can be controlled by adjusting the amount(s) of the emulsifier(s) used.

In the case of using emulsion polymerization, a known polymerization initiator such as 2,2′-azobisisobutyronitrile, hydrogen peroxide, potassium persulfate, or ammonium persulfate can be used as a thermally decomposable initiator.

A redox initiator may be used that contains an organic peroxide such as t-butylperoxyisopropyl carbonate, p-menthane hydroperoxide, cumene hydroperoxide, dicumyl peroxide, t-butyl hydroperoxide, di-t-butyl peroxide, or t-hexyl peroxide or an inorganic peroxide such as hydrogen peroxide, potassium persulfate, or ammonium persulfate, optionally in combination with a reducing agent such as sodium formaldehyde sulfoxylate or glucose, further optionally in combination with a transition metal salt such as iron(II) sulfate, further optionally in combination with a chelate agent such as disodium ethylenediaminetetraacetate, and further optionally in combination with a phosphorus-containing compound such as sodium pyrophosphate.

The use of a redox initiator is preferred because, in this case, the polymerization can be carried out at a low temperature at which the peroxide undergoes substantially no thermal decomposition, and the polymerization temperature can be set over a wide range. In particular, an organic peroxide such as cumene hydroperoxide, dicumyl peroxide, or t-butyl hydroperoxide may be used as the redox initiator. The amount of the initiator used may be as known in the art. In the case of using the redox initiator, the amounts of the reducing agent, transition metal salt, and chelate agent may be as known in the art. In the case of polymerization of a monomer having two or more radical-polymerizable double bonds, a known chain transfer agent can be used in an amount as known in the art. A surfactant can be additionally used, and the amount of the surfactant may likewise be as known in the art.

The solvent used in emulsion polymerization may be any solvent in which the emulsion polymerization can proceed stably. For example, water is suitable for use as the solvent.

The temperature during emulsion polymerization is not limited to a particular range, and may be any temperature at which the emulsifier can be uniformly dissolved in the solvent. The temperature may be, for example, from 40 to 75° C., from 45 to 70° C., or from 49 to 65° C.

When the polymer particles are produced by emulsion polymerization, they can be separated from the aqueous medium, for example, as follows: the latex of the polymer particles is mixed with an acid such as hydrochloric acid or a divalent or higher-valent metal salt such as calcium chloride, magnesium chloride, magnesium sulfate, aluminum chloride, or calcium acetate to coagulate the polymer particles; and the polymer particles are then subjected to heat treatment, dehydration, washing, and drying according to known procedures. The obtained polymer particles may be washed with water and/or an organic solvent.

Alternatively, the polymer particles may be isolated as follows: a water-soluble organic solvent is added to the latex of the polymer particles to precipitate the polymer particles; the polymer particles are then separated from the solvent by centrifugation or filtration; and finally the separated polymer particles are dried. The water-soluble organic solvent may be acetone or an alcohol such as methanol, ethanol, or propanol. Another example is a method in which: a slightly water-soluble organic solvent such as methyl ethyl ketone is added to the latex of the polymer particles to extract the polymer particles into an organic solvent layer in the latex; the organic solvent layer is separated; and the organic solvent layer is then mixed with water or the like to precipitate the polymer particles.

Alternatively, the latex of the polymer particles may be directly processed into a powder by spray drying. The obtained powder may be washed with water and/or an organic solvent. Alternatively, a metal salt such as calcium chloride, magnesium chloride, magnesium sulfate, or aluminum chloride may be added, preferably as a solution such as an aqueous solution, to the obtained powder, which may then be dried again as necessary. This treatment provides the same effect as the washing with water and/or an organic solvent.

### (Acid)

The modifier for polyamide resins according to the present embodiment contains an acid. The inclusion of the acid can improve the fluidity of the polyamide resin composition. The acid contained in the modifier may be an acid that participates in scission of the polyamide main chain. Examples include carboxylic acids and carboxylic anhydrides.

Carboxylic acids are organic acids having one carboxy group or having two or more carboxy groups. Examples include: carboxylic acids such as monocarboxylic, dicarboxylic, tricarboxylic, and tetracarboxylic acids which are classified according to the number of carboxy groups; and aminocarboxylic acids.

Among these, dicarboxylic acids are preferred. At least one dicarboxylic acid selected from the group consisting of oxalic acid, malonic acid, succinic acid, glutaric acid, adipic acid, pimelic acid, suberic acid, azelaic acid, sebacic acid, undecanedicarboxylic acid, dodecanedicarboxylic acid, oxaloacetic acid, phthalic acid, terephthalic acid, isophthalic acid, 2,6-naphthalenedicarboxylic acid, and derivatives of these dicarboxylic acids, may be used. In order to significantly improve the fluidity of the polyamide resin composition, at least one dicarboxylic acid selected from the group consisting of adipic acid, sebacic acid, and terephthalic acid is preferred. More preferred is adipic acid.

Carboxylic anhydrides include: anhydrides derived by dehydration condensation between two molecules of the same or different carboxylic acids selected from the carboxylic acids described above (in particular, dicarboxylic acids and tricarboxylic acids); and anhydrides derived by intramolecular dehydration condensation of the carboxylic acids described above. Specific examples include carboxylic anhydrides derived by intramolecular dehydration condensation of the dicarboxylic acids mentioned above, and at least one carboxylic anhydride selected from the group consisting of such dicarboxylic anhydrides may be used. Trimellitic anhydride is preferred in order to significantly improve the fluidity of the polyamide resin composition.

The acid used may be a mixture of a carboxylic acid and a carboxylic anhydride.

The amount of the acid contained in the modifier for polyamide resins according to the present embodiment is not limited to a particular range. In order to improve the impact strength and fluidity of the polyamide resin composition in a well-balanced manner, the proportion of the acid in the total weight of the polymer particles and the acid in the modifier for polyamide resins may be from 1 to 40 wt %. The proportion may be at least 1 wt % and may be at least 3 wt %, at least 5 wt %, or at least 6 wt %. The proportion may be up to 40 wt % and may be up to 30 wt %.

One method for producing the modifier may include mixing the polymer particles and an acid. In this mixing process, the polymer particles may be in the form of a latex or a powder.

### (Amount of Modifier)

The modifier for polyamide resins according to the present embodiment, which contains the polymer particles detailed above, is used for incorporation into a polyamide resin and capable of improving the impact strength and fluidity of the polyamide resin composition while keeping its high visual quality intact. The amount of the modifier incorporated into the polyamide resin may be set as appropriate. The proportion of the modifier in the total weight of the polyamide resin and the modifier may be from 1 to 40 wt %. When the proportion of the modifier is within this range, the modifier can exhibit an improving effect on the impact strength and fluidity of the polyamide resin composition while keeping intact the inherent physical properties of the polyamide resin and the high visual quality of the polyamide resin composition. The proportion may be from 3 to 30 wt % or from 5 to 25 wt %.

### (Polyamide Resin)

The polyamide resin according to the present embodiment is not limited to a particular type and may be any polymer having an acid amide bond (—CONH—). Examples of such polymers include: a polymer obtained by polycondensation of a diamine with a dibasic acid; a polymer obtained by polycondensation of a diamine derivative such as a diformyl with a dibasic acid; a polymer obtained by polycondensation of a dibasic acid derivative such as a dimethyl ester with a diamine; a polymer obtained by a reaction of a dinitrile or diamide with formaldehyde; a polymer obtained by polyaddition of a diisocyanate with a dibasic acid; a polymer obtained by self-condensation of an amino acid or its derivative; and a polymer obtained by ring-opening polymerization of a lactam. The polyamide resin may contain a polyether block. One polyamide resin may be used alone, or a mixture of two or more polyamide resins may be used.

Specific examples of the polyamide resin include: aliphatic polyamides such as nylon 4, nylon 6, nylon 66, nylon 7, nylon 9, nylon 11, nylon 12, nylon 46, nylon 56, nylon 410, nylon 412, nylon 610, and nylon 612; semi-aromatic polyamides such as nylon 6T, nylon 6I, nylon 9T, nylon 10T, nylon M5T, and nylon MXD6; and copolyamides such as nylon 6/66, nylon 6/12, nylon 6/66/12, nylon 6/6T, nylon 66/6T, nylon 6/6I, nylon 6T/6I, nylon 6T/12, and nylon 66/6T/6I. Among these, nylon 6, nylon 66, nylon 11, and nylon 12 are preferred in terms of versatility.

The polyamide resin according to the present embodiment may be a recycled polyamide resin. In the present disclosure, the term “recycled polyamide resin” refers to a polyamide resin molded into a product, consumed, and discarded or a polyamide resin made by reusing polyamide resin waste discharged in the course of production of polyamide resins or polyamide resin molded articles. The term “recycled polyamide resin” is intended to encompass a mixture of an unused, fresh polyamide resin with a recycled polyamide resin.

### (Another Resin)

The polyamide resin composition according to the present embodiment may not contain a thermoplastic resin other than the polyamide resin, or may contain a thermoplastic resin other than the polyamide resin. When the polyamide resin composition contains a thermoplastic resin other than the polyamide resin, examples of the thermoplastic resin include, but are not limited to, polyethylene, polypropylene, polyvinyl chloride, polystyrene, polyvinyl acetate, polyurethane, polytetrafluoroethylene, ABS resin, AS resin, acrylic resin, polyacetal, polycarbonate, modified polyphenylene ether, polyethylene terephthalate, polybutylene terephthalate, and cyclic polyolefin. The amount of the other thermoplastic resin is not limited to a particular range, but may be, for example, from 0 to 100 parts by weight, from 0 to 50 parts by weight, from 0 to 30 parts by weight, or from 0 to 10 parts by weight per 100 parts by weight of the polyamide resin.

### (Other Additives)

The polyamide resin composition according to the present embodiment may optionally contain additives that can be incorporated into common thermoplastic resin compositions, insofar as the additives do not diminish the effect of one or more embodiments of the present invention. Examples of such additives include, but are not limited to, a colorant, a flame retardant, a flame retardant synergist, an anti-dripping agent, a reinforcing material, a filler, an oxidation inhibitor, a conductive additive, a hydrolysis inhibiter, a thickener, a plasticizer, a lubricant, an antioxidant, an ultraviolet absorber, an antistatic agent, a flow modifier, a mold release agent, a compatibilizer, and a thermal stabilizer.

Examples of the colorant include masterbatches, colored pellets, colored compounds, dry colors, paste colors, and liquid masterbatches. The coloring ingredient contained in the colorant may be, for example, a pigment such as carbon black.

The amount of the coloring ingredient may be set as appropriate. In order to achieve good color development with an efficient usage amount, the amount of the coloring ingredient may be from 0.1 to 3 parts by weight, from 0.1 to 2 parts by weight, or from 0.5 to 1.5 parts by weight per 100 parts by weight of the polyamide resin composition.

In order to enhance impact strength at ambient and low temperatures, the polyamide resin composition according to the present embodiment may further contain a reinforcing material. Examples of the reinforcing material include glass fibers, carbon fibers, boron fibers, asbestos fibers, polyvinyl alcohol fibers, polyester fibers, acrylic fibers, fully aromatic polyamide fibers, polybenzoxazole fibers, polytetrafluoroethylene fibers, kenaf fibers, bamboo fibers, hemp fibers, bagasse fibers, high-strength polyethylene fibers, alumina fibers, silicon carbide fibers, potassium titanate fibers, brass fibers, stainless steel fibers, steel fibers, ceramic fibers, and basalt fibers. Among these, glass fibers, carbon fibers, and metal fibers are preferred because these fibers have a good enhancing effect on impact strength. Glass fibers are more preferred. One reinforcing material may be used alone, or two or more reinforcing materials may be used in combination.

The amount of the reinforcing material may be set as appropriate. In order to enhance impact strength with an efficient usage amount, the amount of the reinforcing material may be from 1 to 50 parts by weight, from 10 to 40 parts by weight, or from 25 to 35 parts by weight per 100 parts by weight of the polyamide resin composition.

### (Method for Producing Composition)

The method used to produce the polyamide resin composition according to the present embodiment is not limited to a particular technique, and may be a common method for producing a thermoplastic resin composition. For example, the polyamide resin composition can be obtained by mixing raw materials using a Henschel mixer or a tumbler mixer and then melting and kneading the mixture. The melting and kneading can be carried out using a kneading device such as a single-screw or twin-screw extruder, a Banbury mixer, a pressure kneader, or a mixing roll mill. Through this melting and kneading, pellets composed of the polyamide resin composition can be produced.

The polyamide resin composition according to the present embodiment can be molded into a molded article having a given shape. The molding method used is not limited to a particular technique, and may be, for example, injection molding, extrusion molding, blow molding, calender molding, blown film molding, rotational molding, or press molding.

### (Applications)

The polyamide resin composition according to the present embodiment and its molded article can be used in various applications by taking advantage of their properties such as being oil resistant, being electrically non-conductive, and having good color developability without surface coating. Examples of the applications include, but are not limited to: automotive products such as cylinder head covers, engine covers, intake manifolds, radiator tanks, oil pans, accelerator pedals, canisters, fuel tubes, air brake tubes, exhaust gas tubes, hydrogen injectors, ducts, industrial fasteners, and door mirror stays; electric/electronic products such as coil bobbins, connectors, gears, sockets, switches, sheathed wires for electric blankets, sheath materials for optical fiber cables, electric tools, electric wire bundling materials, and chargers; mechanical products such as hydraulic or pneumatic connectors or tubes, covers, housings, bearings, pressure-resistant hoses, and bundling bands; building products such as curtain rail parts, aluminum sash corners, door rollers, handrails, curtain rollers, and door handles; sports/leisure products such as sport shoe soles, goods for ski or snowboarding, reels, and diving snorkels; package/container products such as shrink packaging films, food packaging films, alcoholic beverage bottles, and agricultural chemical bottles; daily-use products such as toothbrushes, legs and armrests of chairs, combs, knives, and forks; and medical products such as medical catheters or pipes, medical packs, and surgical sutures.

In the following items, preferred aspects of the present disclosure are listed. The present invention is not limited to the following items.

### [Item 1]

A modifier for polyamide resins, containing:
polymer particles; and
an acid, wherein
each of the polymer particles has a core-shell structure composed of a shell layer and one or more core layers,
at least one of the core layers is formed of polybutadiene, poly(butadiene-styrene), or acrylic rubber, and
the shell layer is formed of a polymer comprising structural units derived from monomer components containing 50 wt % or more of a methacrylic ester monomer and 0 to 50 wt % of another monomer copolymerizable with the methacrylic ester monomer.

### [Item 2]

The modifier for polyamide resins according to item 1, wherein the acid is a dicarboxylic acid.

### [Item 3]

The modifier for polyamide resins according to item 1 or 2, wherein a proportion of a monomer unit having a reactive functional group in constituent monomer units of the polymer of the shell layer is 20 wt % or less.

### [Item 4]

The modifier for polyamide resins according to any one of items 1 to 3, wherein a proportion of the acid in a total weight of the polymer particles and the acid is from 1 to 40 wt %.

### [Item 5]

The modifier for polyamide resins according to any one of items 1 to 4, wherein the core layers exhibit a refractive index of 1.43 or more.

### [Item 6]

The modifier for polyamide resins according to any one of items 1 to 5, wherein the polymer particles have a volume mean diameter of 100 nm or more.

### [Item 7]

A polyamide resin composition containing:
a polyamide resin; and
the modifier for polyamide resins according to any one of items 1 to 6, wherein
a proportion of the modifier in a total weight of the polyamide resin and the modifier is from 1 to 40 wt %.

### [Item 8]

The polyamide resin composition according to item 7, further containing 0.1 to 3 parts by weight of a coloring ingredient per 100 parts by weight of the polyamide resin composition.

### [Item 9]

The polyamide resin composition according to item 7 or 8, further containing 1 to 50 parts by weight of a reinforcing material per 100 parts by weight of the polyamide resin composition.

### [Item 10]

Pellets composed of the polyamide resin composition according to any one of items 7 to 9.

### [Item 11]

A molded article composed of the polyamide resin composition according to any one of items 7 to 9.

### EXAMPLES

Hereinafter, one or more embodiments of the present invention will be described in more detail using examples. The present invention is not limited to the examples described below.

### (Refractive Index of Core Layers)

The refractive index of core layers was measured according to JIS K 7142 using Abbe Refractometer 2T manufactured by Atago Co., Ltd.

### (Mean Diameter of Polymer Particles)

The volume mean diameter of polymer particles was measured for a latex of the polymer particles. The measurement device used was Nanotrac Wave manufactured by Nikkiso Co., Ltd.

### Abbreviations

MBS: Methyl methacrylate-butadiene-styrene copolymer
ACR: (Meth)acrylate copolymer
EMA: Ethylene-methyl acrylate copolymer
EEA: Ethylene-ethyl acrylate copolymer
EBA: Ethylene-butyl acrylate copolymer

### <Method for Producing Core-Shell MBS (Copolymer)>

To 17,000 g of deionized water was added 300 g of disodium hydrogen phosphate (solids content=10%; the unit “%” denotes “wt %, and the same applies hereinafter). A solution prepared by dissolving 0.237 g of iron(II) sulfate (FeSO₄·7H₂O) and 0.395 g of disodium ethylenediaminetetraacetate in 125.8 g of deionized water was further added, and the resulting mixture was deoxygenated at −0.01 MPa for 15 minutes. A 100-L pressure-resistant autoclave was charged with 66.7 g of Neopelex G-15 (sodium dodecylbenzenesulfonate, manufactured by Kao Corporation, solids content=15.0%), 10,000 g of butadiene, and 150 g of t-dodecyl mercaptan, and the internal temperature of the autoclave was raised to 50° C. Subsequently, 140.0 g of sodium formaldehyde sulfoxylate (solids content=5%) and 7.7 g of p-menthane hydroperoxide (solids content=52%) were added to initiate polymerization. Fifteen hours after the start of polymerization, butadiene remaining unconsumed in polymerization was removed by evaporation under reduced pressure to form core particles with a solids concentration of 40%.

An 8-L polymerization reactor was charged with 2000 g of the core particles (solids content=800 g) and heated to 60° C., and nitrogen was allowed to flow through the reactor. A solution prepared by dissolving 0.012 g of iron(II) sulfate (FeSO₄·7H₂O) and 0.058 g of disodium ethylenediaminetetraacetate in 69.3 g of deionized water was introduced into the polymerization reactor, to which a mixture of 150 g of methyl methacrylate, 50 g of styrene, and 0.5 g of t-butyl hydroperoxide (solids content=69%) was then added over 60 minutes. Polymerization was terminated 60 minutes after completion of addition of the mixture, and thus core-shell MBS (copolymer) particles with a diameter of 200 nm were obtained.

### <Method for Producing Core-Shell ACR (Copolymer)>

An 8-L polymerization reactor was charged with 1547 g of deionized water, 4.7 g of boric acid, 18.9 g of sodium carbonate (solids content=2.5%), and 0.1 g of polyoxyethylene lauryl ether phosphate and heated to 80° C., and nitrogen was allowed to flow through the reactor. A solution prepared by dissolving 0.012 g of iron(II) sulfate (FeSO₄·7H₂O) and 0.058 g of disodium ethylenediaminetetraacetate in 69.3 g of deionized water was introduced into the polymerization reactor, to which a mixture of 900 g of butyl acrylate, 4.5 g of allyl methacrylate, 2.0 g of t-butyl hydroperoxide (solids content=69%), and 3.2 g of polyoxyethylene lauryl ether phosphate was then added over 360 minutes. During polymerization, an appropriate amount of sodium hydroxide (solids content=2%) was added at appropriate times to maintain the pH of the system within the range of 5 to 7. Polymerization was terminated 60 minutes after completion of addition of the mixture, and thus core particles were formed.

Subsequently, a mixture of 100 g of methyl methacrylate and 0.5 g of t-butyl hydroperoxide (solids content=69%) was added to the polymerization reactor over 60 minutes. Polymerization was terminated 60 minutes after completion of addition of the mixture, and thus core-shell ACR (copolymer) particles with a diameter of 200 nm were obtained.

### <Method for Producing Non-Core-Shell MBS (Copolymer)>

To 17,000 g of deionized water was added 300 g of disodium hydrogen phosphate (solids content=10%). A solution prepared by dissolving 0.237 g of iron(II) sulfate (FeSO₄·7H₂O) and 0.395 g of disodium ethylenediaminetetraacetate in 125.8 g of deionized water was further added, and the resulting mixture was deoxygenated at −0.01 MPa for 15 minutes. A 100-L pressure-resistant autoclave was charged with 66.7 g of Neopelex G-15 (sodium dodecylbenzenesulfonate, manufactured by Kao Corporation, solids content=15.0%), 8,000 g of butadiene, 500 g of styrene, 1,500 g of methyl methacrylate, and 150 g of t-dodecyl mercaptan, and the internal temperature of the autoclave was raised to 50° C. Subsequently, 140.0 g of sodium formaldehyde sulfoxylate (solids content=5%) and 7.7 g of p-menthane hydroperoxide (solids content=52%) were added to initiate polymerization. Fifteen hours after the start of polymerization, butadiene remaining unconsumed in polymerization was removed by evaporation under reduced pressure to obtain a latex of MBS (copolymer) having no core-shell structure.

### <Method for Producing Non-Core-Shell ACR (Copolymer)>

An 8-L polymerization reactor was charged with 1547 g of deionized water, 4.7 g of boric acid, 18.9 g of sodium carbonate (solids content=2.5%), and 0.1 g of polyoxyethylene lauryl ether phosphate and heated to 80° C., and nitrogen was allowed to flow through the reactor. A solution prepared by dissolving 0.012 g of iron(II) sulfate (FeSO₄·7H₂O) and 0.058 g of disodium ethylenediaminetetraacetate in 69.3 g of deionized water was introduced into the polymerization reactor, to which a mixture of 100 g of methyl methacrylate, 900 g of butyl acrylate, 1 g of t-dodecyl mercaptan, 5 g of allyl methacrylate, 2.5 g of t-butyl hydroperoxide (solids content=69%), and 3.2 g of polyoxyethylene lauryl ether phosphate was then added over 360 minutes. During polymerization, an appropriate amount of sodium hydroxide (solids content=2%) was added at appropriate times to maintain the pH of the system within the range of 5 to 7. Polymerization was terminated 80 minutes after completion of addition of the mixture, and thus a latex of ACR (copolymer) having no core-shell structure was obtained.

### (Production of Powders of Core-Shell and Non-Core-Shell Copolymers)

A mixture of 760 parts by weight of deionized water and 3.3 parts by weight of a 25 wt % aqueous solution of calcium chloride was heated to 60° C. under stirring. The polymer particle latex, to which 2.5 parts by weight of a hindered phenol antioxidant, IRGANOX 1076 (n-octadecyl-3-(3′,5′-di-t-butyl-4′-hydroxyphenyl) propionate), had been added, was introduced into the heated mixture to obtain a slurry containing coagulated latex particles. Subsequently, the slurry was heated to 90° C. for dehydration and drying to obtain a white resin powder of polymer particles.

In addition to the core-shell and non-core-shell copolymer particles described above, the following materials were used as polymer particles.
EMA: LOTRYL 24MA02 of ARKEMA
EEA: NUC-6520 of ENEOS
EBA: LOTRYL 30BA02 of ARKEMA

The following materials were used as acids.
Adipic acid, sebacic acid, and terephthalic acid (all of which are manufactured by FUJIFILM Wako Pure Chemical Corporation)

The following materials were used as polyamide resins.
Polyamide 6 (PA 6): UBE 1030B, manufactured by UBE Corporation
Polyamide 6.6 (PA 66): Reona 1300S, manufactured by Asahi Kasei Corporation

CS-3G-225S, a glass fiber material manufactured by Nitto Boseki Co., Ltd., was used as a reinforcing material.

### Examples 1 to 11, Comparative Examples 1 to 20, and Reference Examples 1 to 4

### (Production of Polyamide Resin Compositions)

Pellets and test specimens formed of a composition containing a polyamide resin and polymer particles or a composition containing a polyamide resin, polymer particles, and an acid and/or a reinforcing material were prepared according to the formulations shown in Tables 1 to 3 and the procedures described below, and these samples were tested for Izod impact strength at ambient and low temperatures, MFR, spiral flow, and L value and gloss as indicators of visual quality. The results are shown in the tables. In Reference Examples 1 to 4, any polymer particles were not used, and the evaluation was conducted for the polyamide resin.

Each of the mixtures prepared according to the formulations shown in Tables 1 to 3 was placed into a twin-screw extruder (TEX 44SS manufactured by The Japan Steel Works, Ltd.) whose barrel temperature was heated to 210 to 270° C., and the mixture was kneaded at a screw rotational speed of 200 rpm and extruded to obtain pellets.

The pellets were dried using a vacuum dryer at 120° C. for 12 hours to fully reduce their moisture content. The dried pellets were processed using an injection molding machine (FAS 100B manufactured by Fanuc Corporation) at a molding temperature of 270° C. and a mold temperature of 80° C. to prepare test specimens.

### (Izod Impact Strength)

A 63.5-mm-long, 12.7-mm-wide, 3.2-mm-thick V-notched test specimen prepared as described above was brought into an absolutely dry state and tested for Izod impact strength at −30° C. and 23° C. according to ASTM D256.

### (L Value)

A 2-mm-thick colored plate was obtained under the same conditions as the test specimen for Izod impact strength was prepared. The colored plate obtained was tested for reflectance L value using a color-difference meter manufactured by Nippon Denshoku Industries Co., Ltd. (Model ZE 6000) according to JIS Z 8741. A lower L value indicates a darker black color and better color developability.

### (Gloss)

A 2-mm-thick colored plate was obtained under the same conditions as the test specimen for Izod impact strength was prepared. The colored plate obtained was tested for 600 specular gloss using a color-difference meter manufactured by Nippon Denshoku Industries Co., Ltd. (Model VG 7000) according to JIS K 8722.

### (MFR)

The pellets prepared under the conditions described above were dried using a vacuum dryer at 120° C. for 12 hours, after which the pellets were tested for MFR at a measurement temperature of 270° C. and a load of 1.2 kg according to the method A of JIS K 7210.

### (Spiral Flow)

The pellets prepared under the conditions described above were dried using a vacuum dryer at 120° C. for 12 hours to fully reduce their moisture content. The dried pellets were directly processed into a spiral flow using an injection molding machine (FAS 100B manufactured by Fanuc Corporation) at a molding temperature of 270° C., a mold temperature of 80° C., and a given injection pressure. The spiral flow length was measured in millimeters.

TABLE 1

| | | | Ref. 1 | Ex. 1 | Ex. 2 | Ex. 3 | Ex. 4 | Ex. 5 | Ex. 6 | Ex. 7 | Comp. 1 |
|---|---|---|---|---|---|---|---|---|---|---|---|
| Polymer particles | Type | | — | Core- | Core-shell | | | | | | Non-core- |
| | | | | shell | ACR | | | | | | shell |
| | | | | MBS | | | | | | | MBS |
| | Parts by weight | | — | 2.8 | 2.8 | 2.8 | 2.8 | 2.6 | 2.2 | 4.6 | 2.8 |
| | Refractive index of core layer | | — | 1.52 | 1.46 | 1.46 | 1.46 | 1.46 | 1.46 | 1.46 | 1.52 |
| | Volume mean | nm | — | 200 | 200 | 200 | 200 | 200 | 200 | 200 | 200 |
| | diameter | | | | | | | | | | |
| Acid | Adipic acid | Parts by weight | — | 0.2 | 0.2 | — | — | 0.4 | 0.8 | 0.4 | 0.2 |
| | Sebacic acid | Parts by weight | — | — | — | 0.2 | — | — | — | — | — |
| | Terephthalic acid | Parts by weight | — | — | — | — | 0.2 | — | — | — | — |
| Polyamide resin | PA6 | Parts by weight | 99.5 | 96.5 | 96.5 | 96.5 | 96.5 | 96.5 | 96.5 | 94.5 | 96.5 |
| | UBE 1030B | | | | | | | | | | |
| Izod impact strength | 23° C. | kJ/m² | 3.4 | 6.4 | 5.2 | 5.4 | 4.9 | 4.9 | 4.6 | 6.8 | 5.3 |
| (notched specimen) | −30° C. | | 1.9 | 4.2 | 3.0 | 3.2 | 2.8 | 3.0 | 2.8 | 4.2 | 3.3 |
| MFR | 1.2 kg 270° C. | cm³/10 min. | 6.7 | 19.5 | 19.9 | 13.7 | 16.5 | 26.6 | 34.5 | 34.3 | 15.4 |
| Spiral flow | 270° C., 800 kg/cm² | mm | 548 | 785 | 790 | 703 | 730 | 905 | 1255 | 1270 | 705 |

| | | | | | | | | | | |
|---|---|---|---|---|---|---|---|---|---|---|
| Visual quality | L value | 5.2 | 5.4 | 5.3 | 5.3 | 5.5 | 5.3 | 5.3 | 5.8 | 6.8 |
| | Gloss | 98 | 97 | 98 | 97 | 98 | 98 | 98 | 96 | 89 |

| | | | Comp. 2 | Comp. 3 | Comp. 4 | Comp. 5 | Comp. 6 | Comp. 7 |
|---|---|---|---|---|---|---|---|---|
| Polymer particles | Type | | Non-core- | EMA | EEA | EBA | Core- | — |
| | | | shell | | | | shell | |
| | | | ACR | | | | ACR | |
| | Parts by weight | | 2.8 | 2.8 | 2.8 | 2.8 | 3 | — |
| | Refractive index of core layer | | 1.46 | — | — | — | 1.46 | — |
| | Volume mean | nm | 200 | — | — | — | 200 | — |
| | diameter | | | | | | | |
| Acid | Adipic acid | Parts by weight | 0.2 | 0.2 | 0.2 | 0.2 | — | 0.2 |
| | Sebacic acid | Parts by weight | — | — | — | — | — | — |
| | Terephthalic acid | Parts by weight | — | — | — | — | — | — |
| Polyamide resin | PA6 | Parts by weight | 96.5 | 96.5 | 96.5 | 96.5 | 96.5 | 99.3 |
| | UBE 1030B | | | | | | | |
| Izod impact strength | 23° C. | kJ/m² | 4.3 | 5.0 | 5.0 | 4.9 | 5.5 | 2.9 |
| (notched specimen) | −30° C. | | 2.8 | 3.0 | 2.9 | 2.9 | 3.3 | 1.4 |
| MFR | 1.2 kg 270° C. | cm³/10 min. | 14.3 | 12.4 | 12.8 | 12.6 | 4.1 | 23.8 |
| Spiral flow | 270° C., 800 kg/cm² | mm | 700 | 690 | 700 | 695 | 507 | 765 |

| | | | | | | | |
|---|---|---|---|---|---|---|---|
| Visual quality | L value | 6.7 | 7.2 | 7.5 | 7.4 | 5.3 | 5.2 |
| | Gloss | 88 | 80 | 81 | 80 | 98 | 98 |

Table 1 shows the results for the cases in which polyamide 6 was used as the polyamide resin. The results reveal that the polyamide resin compositions of Examples 1 to 7, each of which contained core-shell polymer particles and an acid, exhibited higher impact strength and fluidity than the polyamide resin of Reference Example 1 while maintaining the high visual quality of polyamide 6. In contrast, the polyamide resin compositions of Comparative Examples 1 to 5, each of which contained non-core-shell polymer particles and an acid, exhibited lower L values and gloss and had poorer visual quality than the polyamide resin compositions of Examples 1 to 7. This is attributed to the poor dispersibility of the non-core-shell polymer particles. The polyamide resin composition of Comparative Example 6, which contained core-shell polymer particles but no acid, showed an increase in impact strength but had lower fluidity, compared to the polyamide resin of Reference Example 1. The polyamide resin composition of Comparative Example 7, which contained an acid but no polymer particles, exhibited higher fluidity than the polyamide resin of Reference Example 1, but suffered a decrease in impact strength.

TABLE 2

| | | | Ref. 2 | Ex. 8 | Ex. 9 | Comp. 8 | Comp. 9 |
|---|---|---|---|---|---|---|---|
| Polymer particles | Type | | — | Core- | Core- | Non-core- | Non-core- |
| | | | | shell | shell | shell | shell |
| | | | | MBS | ACR | MBS | ACR |
| | Parts by weight | | — | 2.8 | 2.8 | 2.8 | 2.8 |
| | Refractive index of core layer | | — | 1.52 | 1.46 | 1.52 | 1.46 |
| | Volume mean diameter | nm | — | 200 | 200 | 200 | 200 |
| Acid | Adipic acid | Parts by weight | — | 0.2 | 0.2 | 0.2 | 0.2 |
| Polyamide resin | PA66 | Parts by weight | 99.5 | 96.5 | 96.5 | 96.5 | 96.5 |
| | Reona 1300S | | | | | | |
| Izod impact strength | 23° C. | kJ/m² | 2.7 | 4.1 | 3.9 | 3.8 | 3.1 |
| (notched specimen) | −30° C. | | 2.5 | 3.0 | 2.8 | 2.8 | 2.6 |
| MFR | 1.2 kg 270° C. | cm³/10 min. | 100.8 | 133.8 | 136.8 | 134.2 | 136.3 |
| Spiral flow | 270° C., 400 kg/cm² | mm | 525 | 765 | 773 | 758 | 762 |

| | | | | | | |
|---|---|---|---|---|---|---|
| Visual quality | L value | 5.5 | 5.7 | 5.8 | 6.5 | 6.7 |
| | Gloss | 102 | 99 | 98 | 88 | 86 |

| | | | Comp. 10 | Comp. 11 | Comp. 12 |
|---|---|---|---|---|---|
| Polymer particles | Type | | EMA | Core- | — |
| | | | | shell | |
| | | | | ACR | |
| | Parts by weight | | 2.8 | 3 | — |
| | Refractive index of core layer | | — | 1.46 | — |
| | Volume mean diameter | nm | — | 200 | — |
| Acid | Adipic acid | Parts by weight | 0.2 | — | 0.2 |
| Polyamide resin | PA66 | Parts by weight | 96.5 | 96.5 | 99.3 |
| | Reona 1300S | | | | |
| Izod impact strength | 23° C. | kJ/m² | 3.8 | 3.8 | 2.2 |
| (notched specimen) | −30° C. | | 2.8 | 2.8 | 1.9 |
| MFR | 1.2 kg 270° C. | cm³/10 min. | 109.2 | 65.2 | 140.2 |
| Spiral flow | 270° C., 400 kg/cm² | mm | 690 | 485 | 770 |

| | | | | |
|---|---|---|---|---|
| Visual quality | L value | 7.1 | 5.7 | 5.6 |
| | Gloss | 81 | 98 | 102 |

Table 2 shows the results for the cases in which polyamide 6.6 was used as the polyamide resin. The results reveal that the polyamide resin compositions of Examples 8 and 9, each of which contained core-shell polymer particles and an acid, exhibited higher impact strength and fluidity than the polyamide resin of Reference Example 2 while maintaining the high visual quality of polyamide 6.6. In contrast, the polyamide resin compositions of Comparative Examples 8 to 10, each of which contained non-core-shell polymer particles and an acid, exhibited lower L values and gloss and had poorer visual quality than the polyamide resin compositions of Examples 8 and 9. This is attributed to the poor dispersibility of the non-core-shell polymer particles. The polyamide resin composition of Comparative Example 11, which contained core-shell polymer particles but no acid, showed an increase in impact strength but had lower fluidity, compared to the polyamide resin of Reference Example 2. The polyamide resin composition of Comparative Example 12, which contained an acid but no polymer particles, exhibited higher fluidity than the polyamide resin of Reference Example 2, but suffered a decrease in impact strength.

TABLE 3

| | | | Ref. 3 | Ex. 10 | Comp. 13 | Comp. 14 | Comp. 15 | Comp. 16 |
|---|---|---|---|---|---|---|---|---|
| Polymer particles | Type | | — | Core- | Non-core- | EMA | Core- | — |
| | | | | shell | shell | | shell | |
| | | | | ACR | ACR | | ACR | |
| | Parts by weight | | — | 2.8 | 2.8 | 2.8 | 3 | — |
| | Refractive index of core layer | | — | 1.46 | 1.46 | — | 1.46 | — |
| | Volume mean | nm | — | 200 | 200 | — | 200 | — |
| | diameter | | | | | | | |
| Acid | Adipic acid | Parts by weight | — | 0.2 | 0.2 | 0.2 | — | 0.2 |
| Polyamide resin | PA6 | Parts by weight | 69.5 | 66.5 | 66.5 | 66.5 | 66.5 | 69.3 |
| | UBE 1030B | | | | | | | |
| | PA66 | Parts by weight | — | — | — | — | — | — |
| | Reona 1300S | | | | | | | |
| Reinforcing | CS-3G-225S | Parts by weight | 30 | 30 | 30 | 30 | 30 | 30 |
| material: GF | | | | | | | | |
| Izod impact strength | 23° C. | kJ/m² | 13.0 | 13.8 | 13.3 | 12.4 | 13.6 | 8.4 |
| (notched specimen) | −30° C. | | 8.2 | 9.0 | 8.4 | 7.1 | 9.0 | 6.9 |
| MFR | 1.2 kg 270° C. | cm³/10 min. | 1.3 | 9.0 | 6.5 | 5.5 | 1.2 | 7.6 |
| Spiral flow | 270° C., 500 kg/cm² | mm | 323 | 735 | 710 | 500 | 300 | 600 |
| Visual quality | L value | | 8.4 | 9.6 | 17.4 | 17.6 | 9.7 | 9.2 |
| | Gloss | | 60 | 58 | 53 | 21 | 57 | 59 |
| | | | Ref. 4 | Ex. 11 | Comp. 17 | Comp. 18 | Comp. 19 | Comp. 20 |
| Polymer particles | Type | | — | Core- | Non-core- | EMA | Core- | — |
| | | | | shell | shell | | shell | |
| | | | | ACR | ACR | | ACR | |
| | Parts by weight | | — | 2.8 | 2.8 | 2.8 | 3 | — |
| | Refractive index of core layer | | — | 1.46 | 1.46 | — | 1.46 | — |
| | Volume mean | nm | — | 200 | 200 | — | 200 | — |
| | diameter | | | | | | | |
| Acid | Adipic acid | Parts by weight | — | 0.2 | 0.2 | 0.2 | — | 0.2 |
| Polyamide resin | PA6 | Parts by weight | — | — | — | — | — | — |
| | UBE 1030B | | | | | | | |
| | PA66 | Parts by weight | 69.5 | 66.5 | 66.5 | 66.5 | 66.5 | 69.3 |
| | Reona 1300S | | | | | | | |
| Reinforcing | CS-3G-225S | Parts by weight | 30 | 30 | 30 | 30 | 30 | 30 |
| material: GF | | | | | | | | |
| Izod impact strength | 23° C. | kJ/m² | 7.1 | 7.5 | 7.3 | 7.4 | 7.4 | 3.3 |
| (notched specimen) | −30° C. | | 6.5 | 6.8 | 6.5 | 6.5 | 6.8 | 3.0 |
| MFR | 1.2 kg 270° C. | cm³/10 min. | 15.1 | 30.4 | 25.6 | 23.0 | 14.6 | 33.2 |
| Spiral flow | 270° C., 500 kg/cm² | mm | 535 | 820 | 810 | 750 | 533 | 794 |

| | | | | | | | |
|---|---|---|---|---|---|---|---|
| Visual quality | L value | 15.0 | 15.2 | 16.3 | 16.7 | 15.3 | 15.1 |
| | Gloss | 16 | 16 | 12 | 9 | 16 | 16 |

Table 3 shows the results for the cases in which a polyamide resin composition containing a reinforcing material was used. The results reveal that the polyamide resin composition of Example 10 or 11, which contained core-shell polymer particles and an acid, exhibited higher impact strength and fluidity than the polyamide resin composition of Reference Example 3 or 4 while maintaining the high visual quality of polyamide 6 or polyamide 6.6. The polyamide resin compositions of Comparative Examples 13 and 14 or Comparative Examples 17 and 18, each of which contained non-core-shell polymer particles and an acid, exhibited lower L values or gloss and had poorer visual quality than the polyamide resin composition of Example 10 or 11. This is attributed to the poor dispersibility of the non-core-shell polymer particles. The polyamide resin composition of Comparative Example 15 or 19, which contained core-shell polymer particles but no acid, showed an increase in impact strength but had lower fluidity, compared to the polyamide resin composition of Reference Example 3 or 4. The polyamide resin composition of Comparative Example 16 or 20, which contained an acid but no polymer particles, exhibited higher fluidity than the polyamide resin composition of Reference Example 3 or 4, but suffered a decrease in impact strength.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A modifier for polyamide resins, comprising:
polymer particles; and
an acid, wherein:
each of the polymer particles comprises a core-shell structure comprising a shell layer and one or more core layers,
at least one of the core layers comprises polybutadiene, poly(butadiene-styrene), or acrylic rubber, and
the shell layer comprises a polymer comprising structural units derived from monomer components containing 50 wt % or more of a methacrylic ester monomer and 0 to 50 wt % of another monomer copolymerizable with the methacrylic ester monomer.

2. The modifier according to claim 1, wherein the acid is a dicarboxylic acid.

3. The modifier according to claim 1, wherein a proportion of a monomer unit having a reactive functional group in constituent monomer units of the polymer of the shell layer is 20 wt % or less.

4. The modifier according to claim 1, wherein a proportion of the acid in a total weight of the polymer particles and the acid is from 1 to 40 wt %.

5. The modifier according to claim 1, wherein the core layers exhibit a refractive index of 1.43 or more.

6. The modifier according to claim 1, wherein the polymer particles have a volume mean diameter of 100 nm or more.

7. A polyamide resin composition comprising:
a polyamide resin; and
the modifier according to claim 1, wherein
a proportion of the modifier in a total weight of the polyamide resin and the modifier is from 1 to 40 wt %.

8. The polyamide resin composition according to claim 7, further comprising 0.1 to 3 parts by weight of a coloring ingredient per 100 parts by weight of the polyamide resin composition.

9. The polyamide resin composition according to claim 7, further comprising 1 to 50 parts by weight of a reinforcing material per 100 parts by weight of the polyamide resin composition.

10. Pellets comprising the polyamide resin composition according to claim 7.

11. A molded article comprising the polyamide resin composition according to claim 7.

12. The modifier according to claim 2, wherein a proportion of a monomer unit having a reactive functional group in constituent monomer units of the polymer of the shell layer is 20 wt % or less.

13. The modifier according to claim 2, wherein a proportion of the acid in a total weight of the polymer particles and the acid is from 1 to 40 wt %.

14. The modifier according to claim 2, wherein the core layers exhibit a refractive index of 1.43 or more.

15. The modifier according to claim 2, wherein the polymer particles have a volume mean diameter of 100 nm or more.

16. A polyamide resin composition comprising:
a polyamide resin; and
the modifier according to claim 2, wherein
a proportion of the modifier in a total weight of the polyamide resin and the modifier is from 1 to 40 wt %.

17. The polyamide resin composition according to claim 16, further comprising 0.1 to 3 parts by weight of a coloring ingredient per 100 parts by weight of the polyamide resin composition.

18. The polyamide resin composition according to claim 16, further comprising 1 to 50 parts by weight of a reinforcing material per 100 parts by weight of the polyamide resin composition.

19. Pellets comprising the polyamide resin composition according to claim 16.

20. A molded article comprising the polyamide resin composition according to claim 16.
